(19) United States
(12) Patent Application Publication
(10) Pub. No.: US 2026/0196411 A1
(43) Pub. Date: Jul. 9, 2026

(54) MULTILAYER CERAMIC CAPACITOR

(71) Applicant: Murata Manufacturing Co., Ltd., Nagaokakyo-shi (JP)

(72) Inventors: Kentaro ISHIHARA, Nagaokakyo-shi (JP); Hiroyuki WADA, Nagaokakyo-shi (JP); Masahiro WAKASHIMA, Nagaokakyo-shi (JP)

(21) Appl. No.: 19/557,557

(22) Filed: Mar. 5, 2026

Related U.S. Application Data
(63) Continuation of application No. PCT/JP2024/034371, filed on Sep. 26, 2024.

(30) Foreign Application Priority Data
Sep. 29, 2023 (JP) 2023-170275

(51) Int. Cl. H01G 4/12; H01G 4/30

(52) U.S. Cl. CPC H01G 4/1209; H01G 4/30

(57) ABSTRACT

A multilayer ceramic capacitor includes dielectric ceramic layers including crystal grains including a perovskite complex oxide including Ba, Ti, at least one rare earth element Re, and at least one of Ca or Zr. An Re/Ti atomic concentration ratio in a grain interior region GI of the crystal grains is GI(Re), an Re/Ti atomic concentration ratio in a grain boundary region GB of the crystal grains is GB(Re), a Ca/Ti atomic concentration ratio in a grain interior region GI of the crystal grains is GI(Ca), a Ca/Ti atomic concentration ratio in a grain boundary region GB of the crystal grains is GB(Ca), an atomic concentration ratio of a total of Ba and Ca to a total of Ti and Zr is (Ba+Ca)/(Ti+Zr), and about 0.074≥GI(Re)≥about 0.005 and about 1.10≥GB(Re)/GI(Re)≥about 0.90, about 0.250≥GI(Ca)≥about 0 and about 1.10≥GB(Ca)/GI(Ca)≥about 0.90, excluding GI(Ca)=0, and about 0.997<(Ba+Ca)/(Ti+Zr)<about 1.030.

### CROSS REFERENCE TO RELATED APPLICATIONS

This application claims the benefit of priority to Japanese Patent Application No. 2023-170275 filed on Sep. 29, 2023 and is a Continuation Application of PCT Application No. PCT/JP2024/034371 filed on Sep. 26, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In Japanese Unexamined Patent Application Publication No. 2008-135638, a multilayer ceramic capacitor is disclosed in which dielectric layers each including barium titanate crystal grains having a calcium concentration of 0.2 atom % or less and barium calcium titanate crystal grains having a calcium concentration of 0.4 atom % or more and inner electrode layers are alternately stacked. In the multilayer ceramic capacitor described in Japanese Unexamined Patent Application Publication No. 2008-135638, the barium titanate crystal grains and the barium calcium titanate crystal grains include magnesium, two rare earth elements as a combination of one selected from yttrium and holmium and one selected from terbium and dysprosium, and vanadium. The ratios of the amounts of magnesium and the one rare earth element selected from yttrium and holmium included in the middle of the barium titanate crystal grains to the amount of magnesium and the one rare earth element selected from yttrium and holmium near the surface of the barium titanate crystal grains are greater than the ratios of the amounts of magnesium and the one rare earth element selected from yttrium and holmium, respectively, included in the middle of the barium calcium titanate crystal grains to the amount of magnesium and the one rare earth element selected from yttrium and holmium near the surface of the barium calcium titanate crystal grains.

According to Japanese Unexamined Patent Application Publication No. 2008-135638, it is argued that the barium titanate crystal grains are ones that exhibit high cubic crystallinity in a core-shell structure. As a result of coexistence of such barium titanate crystal grains exhibiting high cubic crystallinity with barium calcium titanate crystal grains, dielectric ceramics including the barium titanate crystal grains and the barium calcium titanate crystal grains have high insulation resistance even after firing. Consequently, a multilayer ceramic capacitor that experiences little decrease in insulation resistance over a time course in high-temperature loading testing can be obtained. A multilayer ceramic capacitor in which dielectric layers (hereinafter also referred to as dielectric ceramic layers) include crystal grains that presuppose a core-shell structure as described in Japanese Unexamined Patent Application Publication No. 2008-135638, however, may experience local concentration of electric field when a high electric field strength is applied. In high-temperature loading therefore, testing, its insulation resistance may decrease as time goes by. When considered from the viewpoint of obtaining a multilayer ceramic capacitor having a long high-temperature operating life and high electrical reliability, therefore, there remains room for improvement.

### SUMMARY OF THE INVENTION

Example embodiments of the present invention provide multilayer ceramic capacitors each having a long high-temperature operating life and high electrical reliability.

A multilayer ceramic capacitor according to an example embodiment of the present invention includes a body portion including multiple dielectric ceramic layers and multiple inner electrode layers stacked in a thickness direction and outer electrodes on a surface of the body portion and electrically coupled to the inner electrode layers. The dielectric ceramic layers include crystal grains including a perovskite complex oxide. The perovskite complex oxide includes barium (Ba), titanium (Ti), at least one rare earth element (Re), and at least one of calcium (Ca) or zirconium (Zr). When an Re/Ti atomic concentration ratio in a grain interior region of the crystal grains is defined as GI(Re), and an Re/Ti atomic concentration ratio in a grain boundary region of the crystal grains is defined as GB(Re), about 0.074≥GI(Re)≥about 0.005 and about 1.10≥GB(Re)/GI(Re)≥about 0.90 are both satisfied. When a Ca/Ti atomic concentration ratio in a grain interior region of the crystal grains is defined as GI(Ca), and a Ca/Ti atomic concentration ratio in a grain boundary region of the crystal grains is defined as GB(Ca), about 0.250≥GI(Ca)≥0 and about 1.10≥GB(Ca)/GI(Ca)≥about 0.90 are both satisfied, where cases in which GI(Ca)=0 are excluded. When an atomic concentration ratio of a total of Ba and Ca to a total of Ti and Zr is expressed as (Ba+Ca)/(Ti+Zr), about 0.997<(Ba+Ca)/(Ti+Zr)<about 1.030 is satisfied.

According to example embodiments of the present invention, multilayer ceramic capacitors each having a long high-temperature operating life and high electrical reliability are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view schematically illustrating an example of a multilayer ceramic capacitor according to an example embodiment of the present invention.

FIG. 2 is an example of an LT cross-sectional view, which includes a length direction L and a thickness direction T, along line II-II of the multilayer ceramic capacitor illustrated in FIG. 1.

FIG. 3 is an example of a WT cross-sectional view, which includes a width direction W and the thickness direction T, along line III-III of the multilayer ceramic capacitor illustrated in FIG. 1.

FIG. 4A is an example of an enlarged cross-sectional view of a dielectric ceramic layer 20 sandwiched between inner electrode layers 30. FIG. 4B is a schematic view illustrating an example of crystal grains of the dielectric ceramic layer 20 in the region enclosed by broken lines in FIG. 4A.

FIG. 5A is a bright-field image under a transmission electron microscope of sample 1-1. FIG. 5B is a mapping image representing the distribution of element Dy in sample 1-1.

### DETAILED DESCRIPTION OF THE EXAMPLE EMBODIMENTS

Example embodiments of the present invention will be described in detail below with reference to the drawings.

Multilayer ceramic capacitors according to example embodiments the present invention will be described. The present invention is not limited to the example embodiments described below and may be variously modified and applied within a scope not departing from the gist of the present invention. In addition, combinations of two or more of the individual preferred configurations described in the example embodiments below also fall within the present invention.

Herein, terms indicating relationships between elements (e.g., “perpendicular,” “parallel,” and “orthogonal”) and terms indicating shapes of elements are not expressions representing only strict meanings but are expressions intended to include substantially equivalent ranges, including, for example, differences of about several percent.

The drawings presented below are schematic views, and dimensions, scaling factors for aspect ratios, and the like thereof may differ from those of actual products. In the drawings, the same or corresponding portions are denoted using the same reference numerals. In each drawing, the same or corresponding elements are assigned the same reference numerals, and redundant description thereof is omitted.

FIG. 1 is a perspective view schematically illustrating an example of a multilayer ceramic capacitor according to an example embodiment of the present invention.

The multilayer ceramic capacitor 1 illustrated in FIG. 1 includes a body portion 10 and outer electrodes 11 and 12 provided at the surface of the body portion 10. For the body portion 10, the directions indicated by the double-headed arrows L, W, and T are defined as the length direction, the width direction, and the thickness direction, respectively.

The body portion 10 has, for example, a rectangular parallelopiped shape. In that case, the body portion 10 includes a first primary surface 10a and a second primary surface 10b opposing each other in the thickness direction T, a first side surface 10c and a second side surface 10d opposing each other in the width direction W, which is orthogonal to the thickness direction T, and a first end surface 10e and a second end surface 10f opposing each other in the length direction L, which is orthogonal to the thickness direction T and the width direction W.

At least one of the corner portions or the edge portions of the body portion 10 may be rounded. In this context, a corner portion is a portion at which three surfaces of the body portion 10 intersect, and an edge is a portion at which two surfaces of the body portion 10 intersect.

The outer electrode 11 is provided on the first end surface 10e of the body portion 10. The outer electrode 11 may extend to portions of the first primary surface 10a, the second primary surface 10b, the first side surface 10c, and the second side surface 10d of the body portion 10.

The outer electrode 12 is provided on the second end surface 10f of the body portion 10. The outer electrode 12 may extend to portions of the first primary surface 10a, the second primary surface 10b, the first side surface 10c, and the second side surface 10d of the body portion 10.

The dimensions of the multilayer ceramic capacitor 1 are not particularly limited. For example, the dimension in the length direction L is about 0.4 mm or more and about 5.7 mm or less, the dimension in the width direction W is about 0.2 mm or more and about 5.0 mm or less, and the dimension in the thickness direction T is about 0.125 mm or more and about 5.0 mm or less.

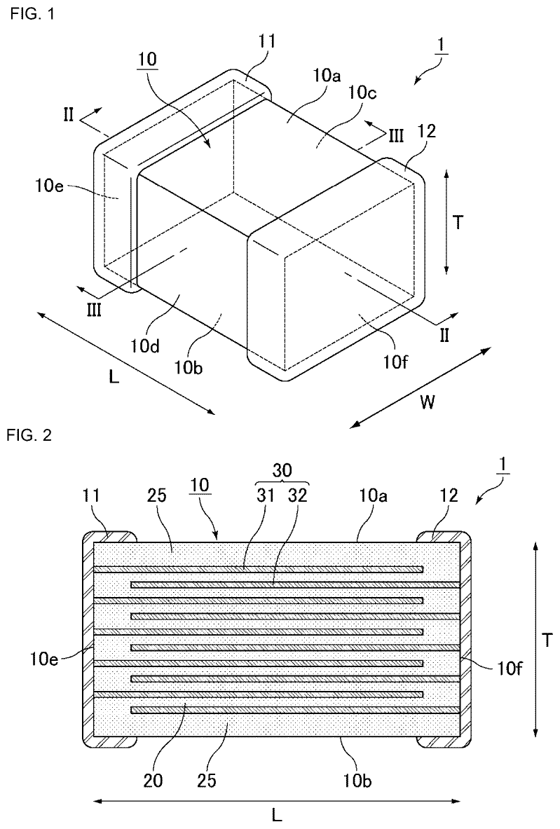

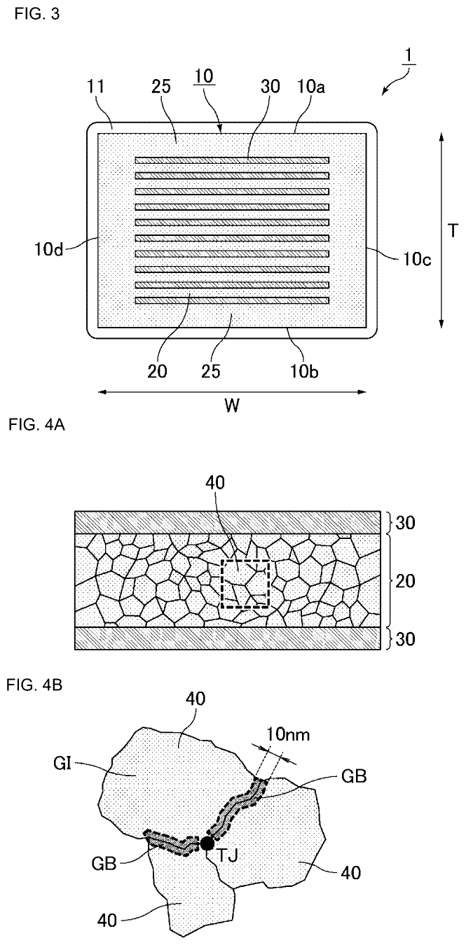

FIG. 2 is an example of an LT cross-sectional view, which includes the length direction L and the thickness direction T, along line II-II of the multilayer ceramic capacitor illustrated in FIG. 1. FIG. 3 is an example of a WT cross-sectional view, which includes the width direction W and the thickness direction T, along line III-III of the multilayer ceramic capacitor illustrated in FIG. 1.

The body portion 10 includes multiple dielectric ceramic layers 20 and multiple inner electrode layers 30 stacked in the thickness direction T.

The inner electrode layers 30 include first inner electrode layers 31 and second inner electrode layers 32 alternately arranged in the thickness direction T.

The first inner electrode layers 31 extend to the first end surface 10e of the body portion 10 and are electrically coupled to the outer electrode 11 there.

The second inner electrode layers 32 extend to the second end surface 10f of the body portion 10 and are electrically coupled to the outer electrode 12 there.

The first inner electrode layers 31 and the second inner electrode layers 32, opposing each other with the dielectric ceramic layers 20 interposed therebetween, are not electrically coupled. When a voltage is applied between the first inner electrode layers 31 and the second inner electrode layers 32 through the outer electrodes 11 and 12, electric charge is accumulated. Capacitance is generated by the accumulated electric charge, such that a function as a capacitive element is provided.

Outside the multiple dielectric ceramic layers 20 and the multiple inner electrode layers 30 stacked in the thickness direction T, outer layer portions 25 each including only stacked dielectric ceramic layers 20 may be provided. The outer layer portions 25 are dielectric ceramic layers located near both primary surfaces of the body portion 10 and each positioned between a primary surface and the inner electrode layer 30 closest to this primary surface. The region sandwiched between the two outer layer portions 25, on the other hand, may also be referred to as an inner layer portion.

FIG. 4A is an example of an enlarged cross-sectional view of a dielectric ceramic layer 20 sandwiched between inner electrode layers 30. FIG. 4B is a schematic view illustrating an example of crystal grains of the dielectric ceramic layer 20 in the region enclosed by broken lines in FIG. 4A.

The dielectric ceramic layers 20 include ceramic. Specifically, the dielectric ceramic layers 20 include, for example, as their main component, crystal grains 40 including a perovskite complex oxide (see FIGS. 4A and 4B). Hereinafter, these crystal grains 40 including a perovskite complex oxide are also referred to as main crystal grains. The main crystal grains include a barium titanate (BaTiO₃) compound. Accordingly, it can also be said that the dielectric ceramic layers 20 include a sintered BaTiO₃ compound. BaTiO₃ is a ferroelectric material that has a tetragonal crystal structure and has a high dielectric constant at room temperature. By using a BaTiO₃ compound as a main component, therefore, the dielectric constant of the dielectric ceramic layers 20 can be increased, such that an increase in the capacitance of the capacitor can be obtained.

Herein, main component refers to the component that has the highest percentage by mass in ceramic. The percentage by mass of the main component is not particularly limited as long as it is less than 100% by mass. For example, it may be about 50% by mass or more, may be about 60% by mass or more, may be about 70% by mass or more, may be about 80% by mass or more, or may be about 90% by mass or more.

The BaTiO₃ compound is not particularly limited as long as it is a perovskite complex oxide mainly including Ba and Ti. For example, the BaTiO₃ compound may be a compound in which a portion of Ba and/or Ti included in BaTiO₃ is substituted with another element. For example, a portion of Ba may be substituted with an alkaline earth metal element, such as strontium (Sr) or calcium (Ca), and a portion of Ti may be substituted with a transition metal element, such as zirconium (Zr) or hafnium (Hf). The molar ratio between the A-site elements (e.g., Ba, Sr, and/or Ca) to the B-site elements (e.g., Ti, Zr, and/or Hf) (hereinafter also referred to as the A/B ratio) in the BaTiO₃ compound, is not strictly limited to 1:1. Deviation of the molar ratio between the A-site elements and the B-site elements is acceptable as long as the compound maintains a perovskite crystal structure.

The perovskite complex oxide of the crystal grains 40 includes barium (Ba), titanium (Ti), and at least one rare earth element (Re). Rare earth element (Re) is a general term for the elements that define the group including scandium (Sc), which has atomic number 21, yttrium (Y), which has atomic number 39, and the elements from lanthanum (La), which has atomic number 57, to lutetium (Lu), which has atomic number 71, in the periodic table. The perovskite complex oxide of the crystal grains 40 may include one rare earth element t (Re) or may include a combination of multiple rare earth elements (Re). The rare earth element (Re), furthermore, may be included solely in the BaTiO₃ compound as the main crystal grains, or may be included in, for example, grain boundaries or triple junctions together with the main crystal grains. When the rare earth element (Re) is included in the main crystal grains, it may occupy the Ba site (A site) of the BaTiO₃ compound, may occupy the Ti site (B site), or may occupy both sites.

Through inclusion of at least one rare earth element (Re) in the dielectric ceramic layers 20, reliability and various characteristics of the multilayer ceramic capacitor 1, such as temperature characteristics of dielectric constant, can be improved. The BaTiO₃ compound as the main component of the dielectric ceramic layers 20 may include a large number of oxygen vacancies generated during a firing step. Such oxygen vacancies are likely to reduce insulation resistance when accompanied by electronic compensation, and also likely to move under an electric field, thus causing a decrease in insulation resistance over time. When at least one rare earth element (Re) is included in the dielectric ceramic layers 20, therefore, the rare earth element (Re) tends to form a solid solution in the Ba site or Ti site of the BaTiO₃ compound. The rare earth element (Re) forming a solid solution defines and functions as a donor or an acceptor, which reduces movement of oxygen vacancies or limits generation of conduction electrons. As a result, the degree of degradation of insulation resistance becomes smaller, and a high-temperature operating life is improved. In addition, BaTiO₃ compounds have a large temperature dependence of dielectric constant in the vicinity of their Curie temperature Tc. Allowing at least one rare earth element (Re) to form a solid solution in the BaTiO₃ compound, therefore, makes it possible to achieve less of a temperature-dependent change in dielectric constant over a wide range of temperatures including the Curie temperature Tc.

The type of the rare earth element (Re) is not particularly limited. However, preferably, for example, the rare earth element (Re) includes at least one of yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu), and more preferably includes at least dysprosium (Dy). Dy is an element located near the middle of the lanthanoid series in the periodic table and also has an ionic radius of an intermediate size. Dy, therefore, can form a solid solution in both the Ba site (A site) and Ti site (B site) of the BaTiO₃ compound, which is effective to improve reliability. The dielectric ceramic layers 20 may include Dy as the only rare earth element (Re) or may include other rare earth elements (Re) together with Dy.

The perovskite complex oxide of the crystal grains 40 may further include at least one of calcium (Ca) or zirconium (Zr). In that case, the element(s) only needs to be included in any of the main crystal grains, grain boundaries, or triple junctions.

When the Re/Ti atomic concentration ratio in a grain interior region GI of the crystal grains 40 is defined as GI(Re), and the Re/Ti atomic concentration ratio in a grain boundary region GB of the crystal grains 40 is defined as GB(Re), for example, about 0.074≥GI(Re)≥about 0.005 (formula 1-1) and about 1.10≥GB(Re)/GI(Re)≥about 0.90 (formula 1-2) are both satisfied.

A region surrounded by boundaries of crystal grains 40 is defined as a grain. First, as illustrated in FIG. 4B, a region defined by interfaces between three or more adjacent grains is defined as a triple junction region TJ. Triple junction region TJ refers to a region including a triple junction, rather than the triple junction itself.

Then, as illustrated in FIG. 4B, a region that includes an interface between two adjacent grains and centered on this interface, that includes no triple junction region TJ, and that has a width of, for example, about 10 nm is defined as a grain boundary region GB. Grain boundary region GB refers to a region including a grain boundary, rather than the grain boundary itself.

After that, as illustrated in FIG. 4B, a region of grain interior that includes no grain boundary region GB and no triple junction region TJ is defined as a grain interior region GI.

Through uniform formation of a solid solution by the rare earth element (Re) throughout the dielectric ceramic layers 20, formula 1-1 and formula 1-2 above can be satisfied. When two or more rare earth elements (Re) are included in the dielectric ceramic layers 20, it is sufficient that the total concentration of the rare earth elements (Re) satisfies formula 1-1 and formula 1-2.

When formula 1-1 is not satisfied and GI(Re)>about 0.074, segregation of the rare earth element (Re) occurs, and thus electrical reliability significantly decreases. When GI(Re)<about 0.005, on the other hand, the advantage of improving electrical reliability by the rare earth element (Re) is less likely to be obtained.

When formula 1-2 is not satisfied, or when GB(Re)/GI(Re)>about 1.10 or GB(Re)/GI(Re)<about 0.90, electric field concentration occurs due to the large difference in the concentration of the rare earth element (Re) between grain interior regions GI and grain boundary regions GB. As a result, electrical reliability decreases.

When the Re/Ti atomic concentration ratio in a triple junction region TJ of the crystal grains 40 is defined as TJ(Re), at least one of about 1.10≥TJ(Re)/GI(Re)≥about 0.90 (formula 1-3) or about 1.10≥TJ(Re)/GB(Re)≥about 0.90 (formula 1-4), for example, may be satisfied.

When the Ca/Ti atomic concentration ratio in a grain interior region GI of the crystal grains 40 is defined as GI(Ca), and the Ca/Ti atomic concentration ratio in a grain boundary region GB of the crystal grains 40 is defined as GB(Ca), about 0.250≥GI(Ca)≥0 (formula 2-1), and about 1.10≥GB(Ca)/GI(Ca)≥about 0.90 (formula 2-2) (where cases in which GI(Ca)=0 are excluded) are both satisfied. When GI(Ca)=0, it is sufficient that only formula 2-1 is satisfied.

When GI(Ca)>0, formula 2-1 and formula 2-2 above can be satisfied through uniform formation of a solid solution by Ca throughout the dielectric ceramic layers 20.

When GI(Ca)=0, on the other hand, it is preferable that GB(Ca)=0.

When formula 2-1 is not satisfied, or when GI(Ca)>about 0.250, a secondary phase appears in the dielectric ceramic layers 20, and thus electrical reliability significantly decreases.

When formula 2-2 is not satisfied, or when GB(Ca)/GI(Ca)>about 1.10 or GB(Ca)/GI(Ca)<about 0.90, electric field concentration occurs due to the large difference in the concentration of Ca between grain interior regions GI and grain boundary regions GB. As a result, electrical reliability decreases.

When the Ca/Ti atomic concentration ratio in a triple junction region TJ of the crystal grains 40 is defined as TJ(Ca), for example, at least one of about 1.10≥TJ(Ca)/GI(Ca)≥about 0.90 (formula 2-3) (where cases in which GI(Ca)=0 are excluded) or about 1.10≥TJ(Ca)/GB(Ca)≥about 0.90 (formula 2-4) (where cases in which GB(Ca)=0 are excluded), for example, may be satisfied. When GI(Ca)=0, it is preferable that GB(Ca)=TJ(Ca)=0.

When the atomic concentration ratio of the total of Ba and Ca to the total of Ti and Zr is expressed as (Ba+Ca)/(Ti+Zr), for example, about 0.997<(Ba+Ca)/(Ti+Zr)<about 1.030 (formula 3) is satisfied. As described above, the dielectric ceramic layers 20 may include Ca or include no Ca, and may include Zr or include no Zr.

When formula 3 is not satisfied and (Ba+Ca)/(Ti+Zr)≤about 0.997, electrical reliability decreases due to generation of a heterogeneous phase in the dielectric ceramic layers 20. In addition, insulation resistance also decreases. When (Ba+Ca)/(Ti+Zr)≥about 1.030, on the other hand, capacitance decreases as a result of a decrease in crystallinity.

From the foregoing description, by satisfying formula 1-

1, formula 1-2, formula 2-1, formula 2-2, and formula 3 above, a multilayer ceramic capacitor 1 having a long high-temperature loading life and high electrical reliability can be obtained.

Formula 1-1 preferably satisfies about 0.074≥GI(Re)≥about 0.05. When this is the case, electrical reliability can be further improved.

Formula 2-1 preferably satisfies about 0.06≥GI(Ca)≥about 0.03. When this is the case, electrical reliability can be further improved.

The various atomic concentration ratios in each region can be determined by, for example, analyzing a cross-section of a dielectric ceramic layer 20 using a transmission electron microscope (TEM)-energy-dispersive X-ray spectrometer (EDX) and performing image analysis on the cross-sectional EDX image obtained.

Specifically, the approximate middle of the multilayer ceramic capacitor 1 is polished so that an LT cross-section is obtained, and dielectric ceramic layers 20 are exposed. TEM observation is performed on main crystal grains in the vicinity of the middle of an exposed dielectric ceramic layer 20, and a mapping image indicating atomic distribution within the crystal grains 40 is obtained using EDX. The observation is preferably performed for 100 crystal grains 40.

The perovskite complex oxide of the crystal grains 40 may further include at least one metal element (M) selected from, for example, vanadium (V), molybdenum (Mo), niobium (Nb), or tantalum (Ta). In this case, the element(s) only needs to be included in any of the main crystal grains, grain boundaries, or triple junctions. The metal element (M) preferably includes, for example, at least vanadium (V).

When the perovskite complex oxide of the crystal grains 40 includes at least one metal element (M), and when the M/Ti atomic concentration ratio in a grain interior region GI of the crystal grains 40 is defined as GI(M), and the M/Ti atomic concentration ratio in a grain boundary region GB of the crystal grains 40 is defined as GB(M), it is preferable that, for example, 0.050≥GI(M)≥0.001 (formula 4-1) is satisfied.

Through formation of a solid solution by the metal element (M) in the dielectric ceramic layers 20, formula 4-1 above can be satisfied. When two or more types of M are included in the dielectric ceramic layers 20, it is sufficient that the total concentration of M satisfies formula 4-1.

When formula 4-1 is not satisfied and GI(M)>about 0.050, it is likely that insulation resistance significantly decreases. When GI(M)<about 0.001, on the other hand, the advantage of improving electrical reliability by M is less likely to be obtained.

Formula 4-1 preferably satisfies, for example, about 0.005≥GI(M)≥about 0.003. When this is the case, electrical reliability can be further improved.

The perovskite complex oxide of the crystal grains 40 may further include additional elements other than the above-described barium (Ba), titanium (Ti), rare earth element(s) (Re), calcium (Ca), zirconium (Zr), and metal element(s) (M). Examples of additional elements include manganese (Mn), magnesium (Mg), silicon (Si), or aluminum (Al). Such elements only need to be included in any of the main crystal grains, grain boundaries, or triple junctions.

The average thickness of the dielectric ceramic layers 20 is not particularly limited. For example, it may be about 0.3 μm or more and about 5 μm or less, may be about 0.4 μm or more and about 4 μm or less, may be about 0.5 μm or more and about 3 μm or less, may be about 0.6 μm or more and about 2 μm or less, or may be about 0.7 μm or more and about 1 μm or less. When the average thickness of the dielectric ceramic layers 20 falls within these ranges, degradation of insulation characteristics can be reduced or prevented. When the average thickness of the dielectric ceramic layers 20 falls within these ranges, furthermore, the dielectric ceramic layers 20 are thin layers, such that improvement in capacitance can be obtained. In addition, the number of dielectric ceramic layers 20 is, for example, 50 or more and 1000 or less.

The average size of the ceramic grains included in the dielectric ceramic layers 20 is not particularly limited. Preferably, for example, it is about 100 nm or more and about 400 nm or less, and more preferably about 150 nm or more and about 300 nm or less.

The inner electrode layers 30 include a conductive metal. The conductive metal can be, for example, an electrode material, such as nickel (Ni), copper (Cu), silver (Ag), palladium (Pd), or an alloy of such metals. The inner electrode layers 30 may further include additional components other than the conductive metal. An example of an additional component is a ceramic component that defines and functions as a common material. An example of a ceramic component is the BaTiO₃ compound included in the dielectric ceramic layers 20.

The average thickness of the inner electrode layers 30 is not particularly limited. For example, it is about 0.3 μm or more and about 0.7 μm or less. When the average thickness of the inner electrode layers 30 falls within this range, defects such as electrode discontinuity are reduced or prevented. When the average thickness of the inner electrode layers 30 falls within this range, furthermore, a decrease in the percentage of electrically functional dielectric ceramic layers 20 in the capacitor is reduced. As a result, it becomes possible to reduce or prevent a decrease in capacitance.

The average thicknesses of the dielectric ceramic layers 20 and the inner electrode layers 30 are determined by, for example, observing a WT cross-section of the body portion 10 exposed by polishing using a scanning electron microscope (SEM), measuring thickness along a total of five lines including the midline parallel to the thickness direction T, which passes through the center of the WT cross-section, and two lines drawn at equal intervals on each side of this midline, and averaging the five measurements.

The average size of the ceramic grains included in the dielectric ceramic layers 20, furthermore, can be measured by analyzing a cross-sectional image obtained by scanning with an SEM. For example, by using software for measuring average grain size according to the standards of JIS G 0551:2013, the average size of the ceramic grains is measured.

The configuration of the outer electrodes 11 and 12 is not particularly limited. The outer electrodes 11 and 12 may have, for example, a multilayer structure including a base layer, a first plating layer, and a second plating layer, from the closest to the end surface of the multilayer ceramic capacitor 1. The base layer includes, for example, a metal, such as nickel (Ni) or copper (Cu). The base layer, furthermore, may include ceramic powder as a common material in addition to the metal. The first plating layer is, for example, a nickel (Ni) plating layer. The second plating layer is, for example, a tin (Sn) plating layer. A conductive resin layer may be provided between the base layer and the first plating layer. The conductive resin layer is a layer including conductive metal particles, for example, of copper (Cu), silver (Ag), or nickel (Ni), and a resin. The configuration of the outer electrodes 11 and 12 is not limited, as long as they are electrically coupled to the inner electrode layers 30 and define and function as external input-output terminals.

For the multilayer ceramic capacitor according to the present example embodiment, a method for manufacturing it is not limited as long as the requirements described above are satisfied.

A non-limiting example of a method for manufacturing a multilayer ceramic capacitor according to the present example embodiment includes, for example, a step of preparing green sheets including at least barium (Ba), titanium (Ti), and at least one rare earth element (Re) (green sheet preparation step), a step of applying a conductive paste to the surface of the green sheets to obtain green sheets with an inner electrode pattern formed thereon (electrode pattern formation step), a step of stacking and pressure-bonding multiple green sheets to obtain a multilayer block (lamination step), a step of cutting the resulting multilayer block to obtain multilayer chips (cutting step), a step of subjecting the resulting multilayer chips to debinding treatment and firing treatment to obtain body portions (firing step), and a step of forming outer electrodes on the resulting body portions (outer electrode formation step). The details of each step will be described below.

In the green sheet preparation step, green sheets including at least barium (Ba), titanium (Ti), and at least one rare earth element (Re) are prepared. The green sheets are precursors of dielectric ceramic layers and include a main-component raw material and additive raw materials for the dielectric ceramic layers. The method for preparing the green sheets is not particularly limited. For example, the green sheets can be prepared by producing a dielectric raw material by mixing additive raw materials into a main-component raw material, adding a binder and a solvent to the resulting dielectric raw material, mixing the materials to form a slurry, and shaping the resulting slurry into green sheets.

The main-component raw material is a powder of a BaTiO₃ compound. The BaTiO₃ compound can be synthesized using a known ceramic synthesis method, such as, for example, solid-phase reaction, hydrothermal synthesis, or alkoxide hydrolysis, with the use of known ceramic raw materials, such as an oxide, a carbonate, a hydroxide, a nitrate, an organic acid salt, an alkoxide, and/or a chelate compound.

When the BaTiO₃ compound is synthesized, for example, a Ba raw material, a Ti raw material, Re raw material(s), and optionally a Ca raw material are wet-stirred using a ball mill, and powder obtained after drying is heated at about 1300° C., for example. In order to facilitate formation of solid solutions by the Re and Ca, furthermore, it is preferable to repeat three times the operation of performing wet pulverization again after heating and then heating the powder.

The Ba raw material is a known ceramic raw material, such as an oxide, a carbonate, or an acetate of Ba, for example.

The Ti raw material is a known ceramic raw material, such as an oxide, a carbonate, an acetate, or a chloride of Ti, for example.

The Re raw material(s) is known ceramic raw material(s), such as oxide(s), carbonate(s), or acetate(s) of the Re, for example.

The Ca raw material is a known ceramic raw material, such as an oxide or a carbonate of Ca, for example.

The additive raw materials may include raw materials for additional additive components, such as Mn, Mg, Si, Al, or V, for example. In order to adjust the composition of the BaTiO₃ compound as the main component, furthermore, for example, a Ba raw material or a Ti raw material, such as barium carbonate (BaCO₃) or titanium oxide (TiO₂), may be added to the additive raw materials.

The slurry formation can be performed using known techniques. For example, it can be performed by mixing an organic binder and an organic solvent into the dielectric raw material. The organic binder is, for example, a known binder, such as a polyvinyl butyral binder. The organic solvent is, for example, a known solvent, such as toluene or ethanol. Additives, such as a plasticizer, for example, may optionally be added to the slurry. The shaping of the slurry into the green sheets, furthermore, can be performed using known techniques, such as doctor blading and LIP, for example.

In the electrode pattern formation step, a conductive paste is applied to the surface of the green sheets, such that green sheets with an inner electrode pattern formed thereon are obtained. The inner electrode patterns become the inner electrode layers after firing. The conductive metal included in the conductive paste is a conductive material such as, for example, nickel (Ni), copper (Cu), silver (Ag), palladium (Pd), or an alloy containing such metals. To the conductive paste, furthermore, a ceramic component that defines and functions as a common material may be added. The ceramic component is, for example, the main-component raw material for the dielectric ceramic layers. The application of the conductive paste can be performed using known techniques, such as screen printing or gravure printing, for example.

In the lamination step, multiple green sheets are stacked and pressure-bonded, such that a multilayer block is obtained. The green sheets are the green sheets with an inner electrode pattern formed thereon, but green sheets without an inner electrode pattern formed thereon may also be used. The stacking and pressure-bonding can be performed using known techniques.

In the cutting step, the resulting multilayer block is cut, such that multilayer chips are obtained. The cutting can be performed such that chips of a predetermined size are obtained and that at least a portion of the inner electrode patterns is exposed on the end surfaces of the multilayer chips.

In the firing step, the resulting multilayer chips are subjected to debinding treatment and firing treatment, such that body portions are obtained. As a result of the firing treatment, the green sheets and the inner electrode patterns are co-sintered and become the dielectric ceramic layers and the inner electrode layers, respectively. The conditions for the debinding treatment can be determined according to the types of organic binders included in the green sheets and the inner electrode patterns. The firing treatment, furthermore, can be performed at a temperature at which the multilayer chips are sufficiently densified. For example, it can be performed under conditions under which the chips are held at a temperature of about 1200° C. or above and about 1300° C. or below for about 1 hour or more and about 10 hours or less. The firing treatment is performed in an atmosphere in which the BaTiO₃ compound as the main component is not reduced and in which oxidation of the conductive metal is limited. For example, it can be performed in a N₂—H₂—H₂O gas stream in which the oxygen partial pressure has been adjusted to about 1.9×10⁻¹¹ MPa or more and about 6.4×10⁻⁹ MPa or less. In addition, annealing treatment may be applied after the firing.

The firing of the multilayer chips is conducted at a temperature elevation rate of, for example, about 400° C./min. By increasing the temperature elevation rate during firing, grain growth can be reduced or prevented. By incorporating a large amount of a glass component, such as Si or Al, for example, as an additive raw material, furthermore, the Re can be dissolved in and forced out into grain boundary regions GB (see FIG. 4B).

In the outer electrode formation step, outer electrodes are formed on the resulting body portions. The formation of the outer electrodes can be performed using known techniques. For example, the outer electrodes can be formed by applying a conductive paste containing metal(s), such as silver (Ag), copper (Cu), and/or nickel (Ni), to the end surfaces of the body portion, on which extended inner electrode layers are exposed, and baking the applied paste. Alternatively, the outer electrodes may be formed by the method of applying a conductive paste to both end surfaces of multilayer chips that have yet to be fired, and then applying firing treatment. The formed electrodes, furthermore, may be used as base layers, and a plating coating, for example of nickel (Ni) or tin (Sn), may be formed thereon. In this manner, multilayer ceramic capacitors are produced.

In the following, examples in which multilayer ceramic capacitors according to example embodiments of the present invention are more specifically disclosed will be presented. It should be noted that the present invention is not limited to these examples of example embodiments.

In Example 1, the influence of the amount of the rare earth element (Re) was examined. In this example, vanadium (V) was used as an example of a metal element (M).

Samples of multilayer ceramic capacitors were prepared in accordance with the process described below.

First, raw material powders, such as BaCO₃ powder, TiO₂ powder, and rare earth oxide powder(s) (e. g., Dy₂O₃ powder), were wet-stirred using a ball mill, and powder obtained after drying was heated at about 1300° C. The operation of performing wet pulverization again after heating and then heating the powder at about 1300° C. was repeated three times, such that dielectric powder was obtained.

A polyvinyl butyral binder and a plasticizer were added to the resulting dielectric powder. Then toluene and ethyl alcohol were added, and a slurry was formed using a wet mill. This slurry was shaped to provide green sheets. The resulting green sheets had a thickness of about 1.7 μm after densification by sintering.

A conductive paste including nickel as its main component was applied to the surface of the resulting green sheets by screen printing, such that patterns of conductive paste layers, intended to be inner electrode layers, were formed.

Thereafter, 201 green sheets with a conductive paste layer formed thereon were stacked such that the surface to which the conductive paste layer was extended alternated. Then a green sheet layer without a conductive paste layer formed thereon was provided above and below the stack, and the entire stack was pressure-bonded. In this manner, a multilayer block was prepared.

The resulting multilayer block was cut into green multilayer chips. The cutting was performed such that the size of the finished multilayer ceramic capacitors would be about 3.2 mm×about 1.6 mm.

The resulting green multilayer chips were subjected to heat treatment at about 280° C. in a N₂ gas stream, such that the binder was burnt off. Subsequently, about 2 hours of firing was performed in a N₂—H₂—H₂O gas stream under conditions of about 1260° C. and an oxygen partial pressure of about 1.6×10⁻⁹ MPa.

To the end surface portions of the fired multilayer chips, to which the inner electrode layers were extended, a conductive paste including Cu as its main component was applied. The applied paste was baked at about 800° C., such that outer electrodes were formed. A Ni plating layer and a Sn plating layer, furthermore, were formed on the surface of the outer electrodes.

In such a manner, multilayer ceramic capacitors of Example 1 were prepared. The resulting multilayer ceramic capacitors had an external shape measuring about 3.2 mm long×about 1.6 mm wide×about 1.6 mm thick. The number of dielectric ceramic layers sandwiched between inner electrode layers was 200, and the thickness of each dielectric ceramic layer was about 1.7 μm.

For the multilayer ceramic capacitors obtained in Example 1, the evaluation of various characteristics was performed as described below.

The dielectric ceramic layers of the multilayer ceramic capacitors were observed using a field-emission transmission electron microscope (FE-TEM), and a composition analysis of a microscopic region was performed using an energy-dispersive X-ray spectrometer (EDX) attached to the TEM. The sample for observation was prepared by processing the dielectric ceramic layers into a slice by FIB lift-out. The observation and analysis were performed under the following conditions:
Apparatus: JEM-2200FS, manufactured by JEOL Ltd./Noran System 7
Fields of view: n=2
Magnification: about 60000 times
Pixel size: about 9.2 nm/pixel
Spot diameter: about 1 nmφ
Measurement: 100 EDX scans

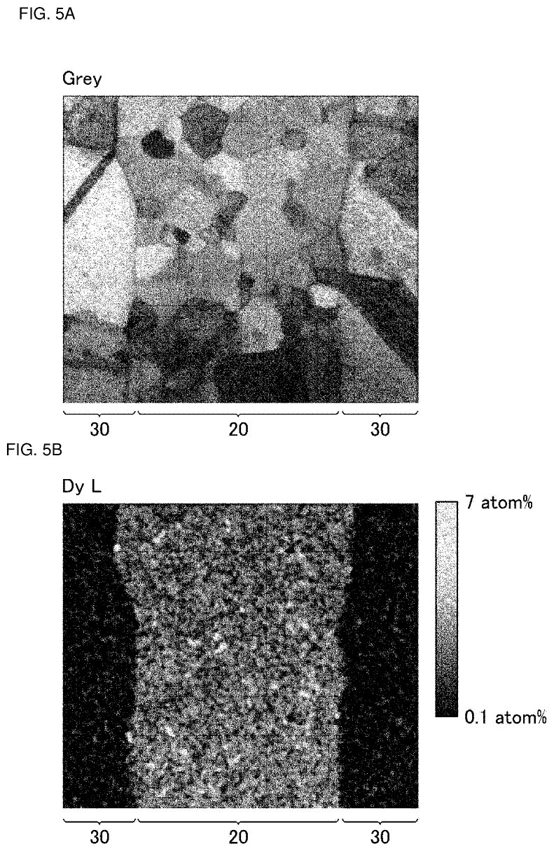

FIG. 5A is a bright-field image under a transmission electron microscope of sample 1-1. FIG. 5B is a mapping image representing the distribution of element Dy in sample 1-1.

For each sample, GI(Re), GB(Re), GI(Ca), and GB(Ca) were determined, and the GB(Re)/GI(Re) ratio and the GB(Ca)/GI(Ca) ratio were calculated. The results are presented in Table 1.

The rare earth element (Re) occupies the A site and the B site, other than the oxygen (O) site, in a perovskite structure, which is expressed as ABO₃. The quantitative ratio of occupation between the sites, however, is not necessarily clear. It is, however, a fact that the rare earth element (Re) substitutes the A site and the B site and forms a solid solution there at a certain ratio, and the compound is in a perovskite structure in that state. The A/B ratio presented in Table 1 represents the (Ba+Ca)/(Ti+Zr) ratio determined by extracting only Ba, Ca, Ti, and Zr in a perovskite structure containing a solid solution of the rare earth element (Re).

Highly accelerated life testing (HALT) was performed on the multilayer ceramic capacitors, and the mean time to failure (MTTF) was determined. In the highly accelerated life testing, the time to failure was measured under two sets of measurement conditions. Specifically, a high-temperature load was applied to samples under conditions of temperature of about 175° C. and test voltage of about 50 V, and conditions of temperature of about 160° C. and a test voltage of about 50 V. The time at which insulation resistance became about 200 kΩ or less was defined as the time to failure. The time to failure was measured for about 72 samples prepared under the same conditions.

Then the data obtained were plotted on Weibull probability paper, such that the Weibull distribution was determined. In the resulting Weibull distribution, the relationship between the time to failure and the cumulative failure rate was modeled using linear regression, and the slope was determined as the shape parameter m. The time to failure at which the cumulative failure rate reached about 63.2% was read. Using this time to failure and the shape parameter m, corresponding to the slope of the regression line, the mean time to failure (MTTF) at a test voltage of about 50 V was determined. Samples for which the MTTF was about 200 hours or longer in highly accelerated life testing under at least one of the two temperature conditions were considered conforming. The results are presented in Table 1.

The presence or absence of a heterogeneous phase in the multilayer ceramic capacitors was evaluated using XRD (powder X-ray diffraction). The sample for evaluation was prepared by pulverizing the multilayer ceramic capacitor in a mortar and removing the electrode portions. The heterogeneous phase (secondary component phase) described in the examples is a crystal phase defined as Dy₂Ti₂O₇. When this crystal phase is present, the MTTF of the dielectric significantly decreases.
Apparatus: D8 Advance, manufactured by Bruker AXS SE
X-ray tube: Cu (sealed X-ray tube)
Optical system: A focusing optical system

The capacitance of each sample was measured, and the dielectric constant was calculated. The measurement was performed using an automatic measuring bridge by applying an AC voltage of about 1 Vrms at about 1 kHz at a temperature of about 25° C. From the capacitance value obtained, the opposing area of the inner electrode layers, and the thickness of the dielectric ceramic layers, dielectric constant Er was calculated.

The insulation resistance of each sample was measured, and the resistivity was calculated. Specifically, insulation resistance was measured using an insulation resistance meter by applying a DC voltage of about 10 V for about 120 seconds at a temperature of about 25° C. Then, from the insulation resistance value obtained, the opposing area of the inner electrode layers, and the thickness of the dielectric ceramic layers, resistivity was calculated.

TABLE 1

| | Blend composition in the | | | | | Microscopic structure | | | |
|---|---|---|---|---|---|---|---|---|---|
| | dielectric ceramic layers | | | | | Uniformity of added elements | | | |
| | | Re | Ca | V | | GI | GB | GI | GB |
| | Re species | (molar parts) | (molar parts) | (molar parts) | A/B | (Re) | (Re) | (Ca) | (Ca) |
| 1-1 | Dy | 0.030 | 0.030 | 0.010 | 1.01 | 0.03 | 0.03 | 0.03 | 0.03 |
| 1-2 | Dy | 0.031 | 0.030 | 0.010 | 1.01 | 0.03 | 0.033 | 0.03 | 0.03 |
| 1-3 | Dy | 0.029 | 0.030 | 0.010 | 1.01 | 0.03 | 0.027 | 0.03 | 0.03 |
| 1-4* | Dy | 0.031 | 0.030 | 0.010 | 1.01 | 0.03 | 0.0336 | 0.03 | 0.03 |
| 1-5* | Dy | 0.029 | 0.030 | 0.010 | 1.01 | 0.03 | 0.0264 | 0.03 | 0.03 |
| 1-6 | Dy | 0.050 | 0.030 | 0.010 | 1.01 | 0.05 | 0.05 | 0.03 | 0.03 |
| 1-7 | Dy | 0.051 | 0.030 | 0.010 | 1.01 | 0.05 | 0.055 | 0.03 | 0.03 |
| 1-8 | Dy | 0.049 | 0.030 | 0.010 | 1.01 | 0.05 | 0.045 | 0.03 | 0.03 |
| 1-9* | Dy | 0.051 | 0.030 | 0.010 | 1.01 | 0.05 | 0.056 | 0.03 | 0.03 |
| 1-10* | Dy | 0.049 | 0.030 | 0.010 | 1.01 | 0.05 | 0.044 | 0.03 | 0.03 |
| 1-11 | Dy | 0.075 | 0.030 | 0.010 | 1.01 | 0.074 | 0.0814 | 0.03 | 0.03 |
| 1-12 | Dy | 0.074 | 0.030 | 0.010 | 1.01 | 0.074 | 0.074 | 0.03 | 0.03 |
| 1-13 | Dy | 0.073 | 0.030 | 0.010 | 1.01 | 0.074 | 0.0666 | 0.03 | 0.03 |
| 1-14* | Dy | 0.076 | 0.030 | 0.010 | 1.01 | 0.074 | 0.08288 | 0.03 | 0.03 |
| 1-15* | Dy | 0.072 | 0.030 | 0.010 | 1.01 | 0.074 | 0.06512 | 0.03 | 0.03 |
| 1-16* | Dy | 0.075 | 0.030 | 0.010 | 1.01 | 0.075 | 0.075 | 0.03 | 0.03 |
| 1-17 | Dy | 0.005 | 0.030 | 0.010 | 1.01 | 0.005 | 0.005 | 0.03 | 0.03 |
| 1-18 | Dy | 0.005 | 0.030 | 0.010 | 1.01 | 0.005 | 0.0045 | 0.03 | 0.03 |
| 1-19* | Dy | 0.004 | 0.030 | 0.010 | 1.01 | 0.004 | 0.004 | 0.03 | 0.03 |
| 1-20* | Dy | 0.005 | 0.030 | 0.010 | 1.01 | 0.005 | 0.0056 | 0.03 | 0.03 |
| 1-21* | Dy | 0.005 | 0.030 | 0.010 | 1.01 | 0.005 | 0.0044 | 0.03 | 0.03 |
| 1-22 | Dy | 0.005 | 0.030 | 0.000 | 1.01 | 0.005 | 0.0045 | 0.03 | 0.03 |
| 1-23 | Dy | 0.030 | 0.030 | 0.000 | 1.01 | 0.005 | 0.0055 | 0.03 | 0.03 |
| 1-24 | Dy | 0.050 | 0.030 | 0.000 | 1.01 | 0.005 | 0.0055 | 0.03 | 0.03 |
| 1-25 | Gd | 0.050 | 0.050 | 0.010 | 1.01 | 0.05 | 0.05 | 0.05 | 0.05 |
| 1-26 | Y | 0.050 | 0.050 | 0.010 | 1.01 | 0.05 | 0.05 | 0.05 | 0.05 |
| 1-27 | Ho | 0.050 | 0.050 | 0.010 | 1.01 | 0.05 | 0.05 | 0.05 | 0.05 |
| 1-28 | Er | 0.050 | 0.050 | 0.010 | 1.01 | 0.05 | 0.05 | 0.05 | 0.05 |
| 1-29 | Dy—Tb | 0.050 | 0.050 | 0.010 | 1.01 | 0.05 | 0.05 | 0.05 | 0.05 |
| 1-30 | Dy—Y—Yb | 0.050 | 0.050 | 0.010 | 1.01 | 0.05 | 0.05 | 0.05 | 0.05 |

| | Microscopic structure | | | Characteristics | | | |
|---|---|---|---|---|---|---|---|
| | | | Heterogeneous phase | MTTF | MTTF | | |
| | Uniformity of | | Relative intensity (%) | (hr) | (hr) | | |
| | added elements | | of the heterogeneous | under | under | Dielectric | Resis- |
| | GB(Re)/ | GB(Ca)/ | phase (secondary | condi- | condi- | constant | tivity |
| | GI(Re) | GI(Ca) | crystal phase) | tion 1 | tion 2 | εr | (GΩ · cm) |
| 1-1 | 1 | 1 | 0 | 247 | 262 | 3400 | 1.3 |
| 1-2 | 1.1 | 1 | 1 | 204 | 219 | 3389 | 1.3 |
| 1-3 | 0.9 | 1 | 0 | 201 | 216 | 3411 | 1.3 |
| 1-4* | 1.12 | 1 | 3 | 52 | 67 | 3387 | 1.3 |
| 1-5* | 0.88 | 1 | 0 | 55 | 70 | 3413 | 1.5 |
| 1-6 | 1 | 1 | 0 | 304 | 319 | 3000 | 1.4 |
| 1-7 | 1.1 | 1 | 1 | 285 | 300 | 2981 | 1.4 |
| 1-8 | 0.9 | 1 | 0 | 290 | 305 | 3019 | 1.4 |
| 1-9* | 1.12 | 1 | 3 | 171 | 186 | 2978 | 1.3 |
| 1-10* | 0.88 | 1 | 0 | 149 | 164 | 3022 | 1.4 |
| 1-11 | 1.1 | 1 | 1 | 277 | 292 | 2492 | 1.5 |
| 1-12 | 1 | 1 | 1 | 320 | 335 | 2520 | 1.5 |
| 1-13 | 0.9 | 1 | 0 | 297 | 312 | 2548 | 1.5 |
| 1-14* | 1.12 | 1 | 3 | 155 | 170 | 2487 | 1.5 |
| 1-15* | 0.88 | 1 | 0 | 170 | 185 | 2553 | 1.5 |
| 1-16* | 1 | 1 | 3 | 168 | 183 | 2500 | 1.5 |
| 1-17 | 1 | 1 | 0 | 215 | 230 | 3900 | 1 |
| 1-18 | 0.9 | 1 | 1 | 204 | 219 | 3902 | 1 |
| 1-19* | 1 | 1 | 0 | 178 | 193 | 3920 | 1 |
| 1-20* | 1.12 | 1 | 3 | 179 | 194 | 3898 | 1 |
| 1-21* | 0.88 | 1 | 0 | 160 | 175 | 3902 | 1 |
| 1-22 | 0.9 | 1 | 0 | 180 | 205 | 3902 | 1 |
| 1-23 | 1.1 | 1 | 0 | 189 | 209 | 3400 | 1 |
| 1-24 | 1.1 | 1 | 0 | 195 | 215 | 3000 | 1 |
| 1-25 | 1 | 1 | 0 | 232 | 247 | 3000 | 1.4 |
| 1-26 | 1 | 1 | 0 | 229 | 244 | 3300 | 1.4 |
| 1-27 | 1 | 1 | 0 | 230 | 245 | 3300 | 1.4 |
| 1-28 | 1 | 1 | 0 | 232 | 247 | 2800 | 1.3 |
| 1-29 | 1 | 1 | 0 | 231 | 246 | 3000 | 1.3 |
| 1-30 | 1 | 1 | 0 | 262 | 277 | 2800 | 1.3 |

In Table 1, the samples marked with * are comparative examples, which are outside the scope of the present invention. The same applies to the other tables.

From Table 1, it can be understood that by satisfying both about 0.074≥GI(Re)≥about 0.005 (formula 1-1) and about 1.10≥GB(Re)/GI(Re)≥about 0.90 (formula 1-2), a multilayer ceramic capacitor having a long MTTF and high electrical reliability can be obtained. In particular, when formula 1-1 satisfied about 0.074≥GI(Re)≥about 0.05, electrical reliability further improved.

In Example 2 of an example embodiment of the present invention, the influence of the amount of calcium (Ca) was examined.

Multilayer ceramic capacitors were prepared by the same method as in Example 1 except that the amount of CaCO₃ powder added when preparing dielectric powder was changed, and various characteristics were evaluated. The results are presented in Table 2.

TABLE 2

| | Blend composition in the | | | | | Microscopic structure | | | |
|---|---|---|---|---|---|---|---|---|---|
| | dielectric ceramic layers | | | | | Uniformity of added elements | | | |
| | | Re | Ca | V | | GI | GB | GI | GB |
| | Re species | (molar parts) | (molar parts) | (molar parts) | A/B | (Re) | (Re) | (Ca) | (Ca) |
| 2-1 | Dy | 0.050 | 0.030 | 0.010 | 1.01 | 0.05 | 0.05 | 0.03 | 0.03 |
| 2-2 | Dy | 0.050 | 0.031 | 0.010 | 1.01 | 0.05 | 0.05 | 0.03 | 0.033 |
| 2-3 | Dy | 0.050 | 0.029 | 0.010 | 1.01 | 0.05 | 0.05 | 0.03 | 0.027 |
| 2-4* | Dy | 0.050 | 0.031 | 0.010 | 1.01 | 0.05 | 0.05 | 0.03 | 0.0336 |
| 2-5* | Dy | 0.050 | 0.029 | 0.010 | 1.01 | 0.05 | 0.05 | 0.03 | 0.0264 |
| 2-6 | Dy | 0.050 | 0.010 | 0.010 | 1.01 | 0.05 | 0.05 | 0.01 | 0.01 |
| 2-7 | Dy | 0.050 | 0.010 | 0.000 | 1.01 | 0.05 | 0.05 | 0.01 | 0.011 |
| 2-8 | Dy | 0.050 | 0.010 | 0.000 | 1.01 | 0.05 | 0.05 | 0.01 | 0.009 |
| 2-9 | Dy | 0.050 | 0.010 | 0.010 | 1.01 | 0.05 | 0.05 | 0.01 | 0.011 |
| 2-10 | Dy | 0.050 | 0.010 | 0.010 | 1.01 | 0.05 | 0.05 | 0.01 | 0.009 |
| 2-11* | Dy | 0.050 | 0.010 | 0.010 | 1.01 | 0.05 | 0.05 | 0.01 | 0.0112 |
| 2-12* | Dy | 0.050 | 0.010 | 0.010 | 1.01 | 0.05 | 0.05 | 0.01 | 0.0088 |
| 2-13 | Dy | 0.050 | 0.040 | 0.010 | 1.01 | 0.05 | 0.05 | 0.04 | 0.04 |
| 2-14 | Dy | 0.050 | 0.041 | 0.010 | 1.01 | 0.05 | 0.05 | 0.04 | 0.044 |
| 2-15 | Dy | 0.050 | 0.039 | 0.010 | 1.01 | 0.05 | 0.05 | 0.04 | 0.036 |
| 2-16* | Dy | 0.050 | 0.041 | 0.010 | 1.01 | 0.05 | 0.05 | 0.04 | 0.0448 |
| 2-17* | Dy | 0.050 | 0.039 | 0.010 | 1.01 | 0.05 | 0.05 | 0.04 | 0.0352 |
| 2-18 | Dy | 0.050 | 0.060 | 0.010 | 1.01 | 0.05 | 0.05 | 0.06 | 0.06 |
| 2-19 | Dy | 0.050 | 0.061 | 0.010 | 1.01 | 0.05 | 0.05 | 0.06 | 0.066 |
| 2-20 | Dy | 0.050 | 0.059 | 0.010 | 1.01 | 0.05 | 0.05 | 0.06 | 0.054 |
| 2-21* | Dy | 0.050 | 0.061 | 0.010 | 1.01 | 0.05 | 0.05 | 0.06 | 0.0672 |
| 2-22* | Dy | 0.050 | 0.059 | 0.010 | 1.01 | 0.05 | 0.05 | 0.06 | 0.0528 |
| 2-23 | Dy | 0.050 | 0.250 | 0.010 | 1.01 | 0.05 | 0.05 | 0.25 | 0.25 |
| 2-24 | Dy | 0.050 | 0.255 | 0.010 | 1.01 | 0.05 | 0.05 | 0.25 | 0.275 |
| 2-25 | Dy | 0.050 | 0.245 | 0.010 | 1.01 | 0.05 | 0.05 | 0.25 | 0.225 |
| 2-26* | Dy | 0.050 | 0.256 | 0.010 | 1.01 | 0.05 | 0.05 | 0.25 | 0.28 |
| 2-27* | Dy | 0.050 | 0.244 | 0.010 | 1.01 | 0.05 | 0.05 | 0.25 | 0.22 |
| 2-28* | Dy | 0.050 | 0.260 | 0.010 | 1.01 | 0.05 | 0.05 | 0.26 | 0.26 |
| 2-29 | Dy | 0.050 | 0.000 | 0.010 | 1.01 | 0.05 | 0.05 | 0 | 0 |

| | Microscopic structure | | | Characteristics | | | |
|---|---|---|---|---|---|---|---|
| | | | Heterogeneous phase | MTTF | MTTF | | |
| | Uniformity of | | Relative intensity (%) | (hr) | (hr) | | |
| | added elements | | of the heterogeneous | under | under | Dielectric | Resis- |
| | GB(Re)/ | GB(Ca)/ | phase (secondary | condi- | condi- | constant | tivity |
| | GI(Re) | GI(Ca) | crystal phase) | tion 1 | tion 2 | εr | (GΩ · cm) |
| 2-1 | 1 | 1 | 1 | 304 | 334 | 3800 | 1.3 |
| 2-2 | 1 | 1.1 | 1 | 260 | 290 | 3794 | 1.3 |
| 2-3 | 1 | 0.9 | 0 | 251 | 281 | 3806 | 1.3 |
| 2-4* | 1 | 1.12 | 3 | 117 | 147 | 3793 | 1.1 |
| 2-5* | 1 | 0.88 | 3 | 82 | 112 | 3807 | 1.1 |
| 2-6 | 1 | 1 | 1 | 220 | 250 | 4000 | 1.3 |
| 2-7 | 1 | 1.1 | 1 | 195 | 225 | 3998 | 1.3 |
| 2-8 | 1 | 0.9 | 0 | 180 | 220 | 4002 | 1.3 |
| 2-9 | 1 | 1.1 | 1 | 211 | 241 | 3998 | 1.3 |
| 2-10 | 1 | 0.9 | 0 | 201 | 231 | 4002 | 1.3 |
| 2-11* | 1 | 1.12 | 3 | 101 | 131 | 3998 | 1.1 |
| 2-12* | 1 | 0.88 | 3 | 21 | 51 | 4002 | 1.1 |
| 2-13 | 1 | 1 | 1 | 311 | 341 | 3700 | 1.3 |
| 2-14 | 1 | 1.1 | 1 | 265 | 295 | 3693 | 1.3 |
| 2-15 | 1 | 0.9 | 0 | 255 | 285 | 3707 | 1.3 |
| 2-16* | 1 | 1.12 | 3 | 112 | 142 | 3691 | 1.1 |
| 2-17* | 1 | 0.88 | 3 | 25 | 55 | 3709 | 1.1 |
| 2-18 | 1 | 1 | 1 | 287 | 317 | 3500 | 1.3 |
| 2-19 | 1 | 1.1 | 1 | 255 | 285 | 3489 | 1.3 |
| 2-20 | 1 | 0.9 | 0 | 250 | 280 | 3511 | 1.3 |
| 2-21* | 1 | 1.12 | 3 | 99 | 129 | 3487 | 1.1 |
| 2-22* | 1 | 0.88 | 3 | 21 | 51 | 3513 | 1.1 |
| 2-23 | 1 | 1 | 1 | 221 | 251 | 1600 | 1.5 |
| 2-24 | 1 | 1.1 | 0 | 208 | 238 | 1553 | 1.5 |
| 2-25 | 1 | 0.9 | 1 | 218 | 248 | 1647 | 1.5 |
| 2-26* | 1 | 1.12 | 3 | 95 | 125 | 1544 | 1 |
| 2-27* | 1 | 0.88 | 3 | 91 | 121 | 1656 | 1 |
| 2-28* | 1 | 1 | 1 | 91 | 121 | 1500 | 1 |
| 2-29 | 1 | 1 | 0 | 215 | 245 | 4100 | 1.3 |

From Table 2, it can be understood that by satisfying both about 0.250≥GI(Ca)≥0 (formula 2-1) and about 1.10≥GB(Ca)/GI(Ca)≥about 0.90 (formula 2-2) (when cases in which GI(Ca)=0 are excluded), a multilayer ceramic capacitor having a long MTTF and high electrical reliability can be obtained. In particular, when formula 2-1 satisfied about 0.06≥GI(Ca)≥about 0.03, electrical reliability further improved.

In Example 3 of an example embodiment of the present invention, the influence of the amount of the metal element (M) was examined.

Multilayer ceramic capacitors were prepared by the same method as in Example 1 except that the amount of V₂O₅ powder added when preparing dielectric powder was changed, and various characteristics were evaluated. The results are presented in Table 3.

For the amount of Ti used to calculate the V/Ti atomic concentration ratio, a composition analysis was performed by WD-XRF (wavelength-dispersive X-ray fluorescence). The sample for evaluation was prepared by pulverizing the multilayer ceramic capacitor in a mortar such that the total weight was about 0.1 g. Measurement conditions are specified below:
Pretreatment: The glass bead method
Measurement diameter: about 30 nmφ

For the amount of V used to calculate the V/Ti atomic concentration ratio, a composition analysis was performed by ICP-(inductively coupled plasma atomic emission spectroscopy). AES The sample for evaluation was prepared by pulverizing the multilayer ceramic capacitor in a mortar and dissolving the powder in acid. Measurement conditions are specified below:
Apparatus: iCAP6300 (manufactured by Thermo Fisher Scientific Inc.)
Measurement wavelength range: 166 to 847 nm
Analysis method: Acid dissolution

TABLE 3

| | Blend composition in the | | | | | Microscopic structure | | | | |
|---|---|---|---|---|---|---|---|---|---|---|
| | dielectric ceramic layers | | | | | Uniformity of added elements | | | | |
| | | Re | Ca | V | | GI | GB | GI | GB | GB(Re)/ |
| | Re species | (molar parts) | (molar parts) | (molar parts) | A/B | (Re) | (Re) | (Ca) | (Ca) | GI(Re) |
| 3-1 | Dy | 0.030 | 0.030 | 0.0010 | 1.01 | 0.03 | 0.03 | 0.03 | 0.03 | 1 |
| 3-2 | Dy | 0.030 | 0.030 | 0.0030 | 1.01 | 0.03 | 0.03 | 0.03 | 0.03 | 1 |
| 3-3 | Dy | 0.030 | 0.030 | 0.0050 | 1.01 | 0.03 | 0.03 | 0.03 | 0.03 | 1 |
| 3-4 | Dy | 0.030 | 0.030 | 0.0500 | 1.01 | 0.03 | 0.03 | 0.03 | 0.03 | 1 |

| | Microscopic structure | | | | | |
|---|---|---|---|---|---|---|
| | | | Heterogeneous phase | | | |
| | Uniformity of | | Relative intensity (%) | Characteristics | | |
| | added elements | | of the heterogeneous | MTTF | Dielectric | |
| | GB(Ca)/ | GI | phase (secondary | (hr) under | constant | Resistivity |
| | GI(Ca) | (M) | crystal phase) | condition 2 | εr | (GΩ · cm) |
| 3-1 | 1 | 0.001 | 1 | 232 | 3790 | 1.4 |
| 3-2 | 1 | 0.003 | 1 | 251 | 3220 | 1.3 |
| 3-3 | 1 | 0.005 | 1 | 245 | 3100 | 1.2 |
| 3-4 | 1 | 0.05 | 1 | 225 | 3010 | 1 |

From Table 3, it can be understood that by satisfying about 0.050≥GI(M)≥about 0.001 (formula 4-1), a multilayer ceramic capacitor not only having a long MTTF and high electrical reliability but also having superior insulation characteristics with high insulation resistance can be obtained. In particular, when formula 4-1 satisfied about 0.005≥GI(M)≥about 0.003, electrical reliability further improved.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a body portion including a plurality of dielectric ceramic layers and a plurality of inner electrode layers stacked in a thickness direction; and
outer electrodes on a surface of the body portion and electrically coupled to the inner electrode layers; wherein
the dielectric ceramic layers include crystal grains including a perovskite complex oxide;
the perovskite complex oxide includes barium (Ba), titanium (Ti), and at least one rare earth element (Re), and further includes at least one of calcium (Ca) or zirconium (Zr);
when an Re/Ti atomic concentration ratio in a grain interior region of the crystal grains is defined as GI(Re), and an Re/Ti atomic concentration ratio in a grain boundary region of the crystal grains is defined as GB(Re), about 0.074≥GI(Re)≥about 0.005 and about 1.10≥GB(Re)/GI(Re)≥about 0.90 are both satisfied;
when a Ca/Ti atomic concentration ratio in a grain interior region of the crystal grains is defined as GI(Ca), and a Ca/Ti atomic concentration ratio in a grain boundary region of the crystal grains is defined as GB(Ca), about 0.250≥GI(Ca)≥0 and about 1.10≥GB(Ca)/GI(Ca)≥about 0.90 are both satisfied, where cases in which GI(Ca)=0 are excluded; and
when an atomic concentration ratio of a total of Ba and Ca to a total of Ti and Zr is expressed as (Ba+Ca)/(Ti+Zr), about 0.997<(Ba+Ca)/(Ti+Zr)<about 1.030 is satisfied.

2. The multilayer ceramic capacitor according to claim 1, wherein about 0.074≥GI(Re)≥about 0.05 is satisfied.

3. The multilayer ceramic capacitor according to claim 1, wherein about 0.06≥GI(Ca)≥about 0.03 is satisfied.

4. The multilayer ceramic capacitor according to claim 1, wherein the perovskite complex oxide further includes at least one metal element (M) of vanadium (V), molybdenum (Mo), niobium (Nb), or tantalum (Ta).

5. The multilayer ceramic capacitor according to claim 4, wherein when an M/Ti atomic concentration ratio in a grain interior region of the crystal grains is defined as GI(M), and an M/Ti atomic concentration ratio in a grain boundary region of the crystal grains is defined as GB(M), about 0.050≥GI(M)≥about 0.001 is satisfied.

6. The multilayer ceramic capacitor according to claim 5, wherein about 0.005≥GI(M)≥about 0.003.

7. The multilayer ceramic capacitor according to claim 4, wherein the metal element (M) includes at least vanadium (V).

8. The multilayer ceramic capacitor according to claim 1, wherein the rare earth element (Re) includes at least one of yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu).

9. The multilayer ceramic capacitor according to claim 8, wherein the rare earth element (Re) includes at least dysprosium (Dy).

10. The multilayer ceramic capacitor according to claim 1, wherein
a dimension of the multilayer ceramic capacitor in a length direction is about 0.4 mm or more and about 5.7 mm or less;
a dimension of the multilayer ceramic capacitor in a width direction W is about 0.2 mm or more and about 5.0 mm or less; and
a dimension of the multilayer ceramic capacitor in a thickness direction is about 0.125 mm or more and about 5.0 mm or less.

11. The multilayer ceramic capacitor according to claim 1, wherein a portion of the Ba is substituted with an alkaline earth metal element.

12. The multilayer ceramic capacitor according to claim 11, wherein the alkaline earth metal element includes strontium.

13. The multilayer ceramic capacitor according to claim 1, wherein a portion of the Ti is substituted with a transition metal element.

14. The multilayer ceramic capacitor according to claim 13, wherein the transition metal element includes hafnium.

15. The multilayer ceramic capacitor according to claim 1, wherein an average thickness of the plurality of dielectric ceramic layers is about 0.3 μm or more and about 5 μm or less.

16. The multilayer ceramic capacitor according to claim 1, wherein an average thickness of the plurality of dielectric ceramic layers is about 0.4 μm or more and about 4 μm or less.

17. The multilayer ceramic capacitor according to claim 1, wherein an average thickness of the plurality of dielectric ceramic layers is about 0.5 μm or more and about 3 μm or less.

18. The multilayer ceramic capacitor according to claim 1, wherein an average thickness of the plurality of dielectric ceramic layers is about 0.6 μm or more and about 2 μm or less.

19. The multilayer ceramic capacitor according to claim 1, wherein an average thickness of the plurality of dielectric ceramic layers about 0.7 μm or more and about 1 μm or less.

20. The multilayer ceramic capacitor according to claim 1, wherein an average thickness of the plurality of inner electrode layers is about 0.3 μm or more and about 0.7 μm or less.
